(19) United States
(12) Patent Application Publication
(10) Pub. No.: US 2011/0258897 A1
(43) Pub. Date: Oct. 27, 2011

(54) Frame Systems for Signage and Methods Relating Thereto

(75) Inventors: Willard M. Dorsey, Taylors, SC (US); Kevin W. Dill, Taylors, SC (US); Charles D. Driskell, Greer, SC (US)

(73) Assignee: B2B Media, LLC, Greenville, SC (US)

(21) Appl. No.: 13/093,120

(22) Filed: Apr. 25, 2011

Related U.S. Application Data
(60) Provisional application No. 61/327,393, filed on Apr. 23, 2010.

(51) Int. Cl. A47G 1/06; G09F 21/04; B23P 11/00; G09F 15/00

(52) U.S. Cl. 40/780; 29/428

(57) ABSTRACT

In certain embodiments of the present disclosure, a frame assembly is described. The frame assembly includes at least two connector elements. Each connector element has two legs with each leg including a tab. The frame assembly also includes at least two frame elements having a pair of first openings. Each first opening can receive a connector element leg. Each frame element further has a pair of second openings that are adjacent to a first opening and that can receive a tab. The frame assembly also includes a panel. Each frame element has a two different connector element legs joined thereto at each respective first opening and two different connector element tabs at each respective second opening such that the at least two frame elements are joined together to form a frame, with the panel being enclosed therein.

### CROSS-REFERENCE TO RELATED APPLICATION

The present application is based on and claims priority to U.S. Provisional Application Ser. No. 61/327,393 having a filing date of Apr. 23, 2010, which is incorporated by reference herein.

### BACKGROUND

The concept of a frame having a rectangular or other shape is not new technology. Similarly, many systems and methods have been used to adhere signage to the side of a vehicle, building, or other object. Certain patents exist for extruded aluminum frame members and for various ways of holding such frame members together.

Reference is made to the following patents (all of which are incorporated by reference herein) which describe various sign frames:

| | | |
|---|---|---|
| 5,911,525 | Jepsen, et al. | Sign Frame; |
| 5,265,358 | Borod | Picture Frame Corner Connector; |
| 5,058,297 | McGinnis | Picture Frame Assembly; |
| 4,676,686 | Eisenloffel | Corner Clamp for Picture Frame; |
| 4,348,826 | Reim | Frame for Pictures; |
| 4,348,127 | Hays, Jr. | Connector for Extruded Sections; and |
| 3,514,886 | Drakard et al. | Frames. |

However, such patents fail to address certain problems in the art. In this regard, a need exists for a method of easily assembling and removing a member of a frame assembly without the need for special tools or without damaging the object to which the frame assembly has been affixed. In addition, a need exists for a frame assembly that allows for the panel within the frame to be changed without a need to access the front and rear faces of the frame.

Thus, a frame assembly which allows for rapid removal and reattachment of a frame member to change a panel therein would be desirable. A motor vehicle incorporating such a frame assembly would be particularly beneficial.

### SUMMARY

Aspects and advantages of the disclosure will be set forth in part in the following description, or may be obvious from the description, or may be learned through practice of the disclosure.

In certain embodiments of the present disclosure, a frame assembly is described. The frame assembly includes at least two connector elements. Each connector element has two legs with each leg including a tab. The frame assembly also includes at least two frame elements having a pair of first openings. Each first opening can receive a connector element leg. Each frame element further has a pair of second openings that are adjacent to a first opening and that can receive a tab. The frame assembly also includes a panel. Each frame element has a two different connector element legs joined thereto at each respective first opening and two different connector element tabs at each respective second opening such that the at least two frame elements are joined together to form a frame, with the panel being enclosed therein.

In still other embodiments of the present disclosure, a method of installing a frame assembly is described. The method includes affixing at least one frame element to a surface. The frame element is joined to at least one other non-surface affixed frame element by at least two connector elements. Each connector element has two legs, with each leg including a tab. Each frame element has a pair of first openings that can receive a connector element leg. Each frame element further has a pair of second openings that are adjacent to a first opening and can receive a tab. Each frame element has a two different connector element legs joined thereto at each respective first opening and two different connector element tabs at each respective second opening such that the at least two frame elements are joined together to form a frame.

These and other features, aspects and advantages of the present disclosure will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure, including the best mode thereof, directed to one of ordinary skill in the art, is set forth more particularly in the remainder of the specification, which makes reference to the appended figures in which:

FIG. 1 illustrates an exploded perspective view of a frame assembly in accordance with certain embodiments of the present disclosure;

FIG. 2 illustrates a frame assembly with left vertical frame member removed to replace panel in accordance with certain embodiments of the present disclosure;

FIG. 3 illustrates a cross section view of a frame member taken along line A-A in FIG. 1 in accordance with certain embodiments of the present disclosure;

FIG. 4A illustrates a front view of a corner connector in accordance with certain embodiments of the present disclosure;

FIG. 4B illustrates a perspective view of a corner connector in accordance with certain embodiments of the present disclosure;

FIG. 4C illustrates a side view of a corner connector in accordance with certain embodiments of the present disclosure;

FIG. 5 illustrates a front corner of the frame assembly of FIG. 1 in exploded view in accordance with certain embodiments of the present disclosure;

FIG. 6 illustrates a rear corner of the frame assembly of FIG. 1 in perspective view in accordance with certain embodiments of the present disclosure;

FIG. 7A illustrates a front view of a front corner of the frame assembly of FIG. 1 in accordance with certain embodiments of the present disclosure;

FIG. 7B illustrates a cross-sectional view of a front corner of the frame assembly taken along line A-A of FIG. 7A in accordance with certain embodiments of the present disclosure;

FIG. 7C illustrates a cross-sectional view of a front corner of the frame assembly taken along line B-B of FIG. 7A in accordance with certain embodiments of the present disclosure;

FIG. 8 illustrates a perspective view of a corner section view of a frame member in accordance with certain embodiments of the present disclosure;

FIG. 9 illustrates installation of a frame assembly on a utility van in accordance with certain embodiments of the present disclosure;

FIG. 10A illustrates a frame assembly on the side of the utility van of FIG. 9 in accordance with certain embodiments of the present disclosure;

FIG. 10B illustrates a frame assembly on the back of the utility van of FIG. 9 in accordance with certain embodiments of the present disclosure; and

FIG. 11 illustrates a frame assembly on the side of a box van in accordance with certain embodiments of the present disclosure.

### DETAILED DESCRIPTION

Reference now will be made in detail to various embodiments of the disclosure, one or more examples of which are set forth below. Each example is provided by way of explanation of the disclosure, not limitation of the disclosure. In fact, it will be apparent to those skilled in the art that various modifications and variations can be made in the present disclosure without departing from the scope or spirit of the disclosure. For instance, features illustrated or described as part of one embodiment, can be used on another embodiment to yield a still further embodiment. Thus, it is intended that the present disclosure covers such modifications and variations as come within the scope of the appended claims and its equivalents.

The present disclosure generally describes a frame assembly for a vehicle. However, the frame assembly of the present disclosure is also contemplated for use in a variety of other applications as will be described in more detail herein. The frame assembly advantageously allows for rapid removal and reattachment of a frame member to change a panel, such as an advertising panel, that is located therein. Such panel can include a protective exterior layer and an interior layer that carries the media to be presented.

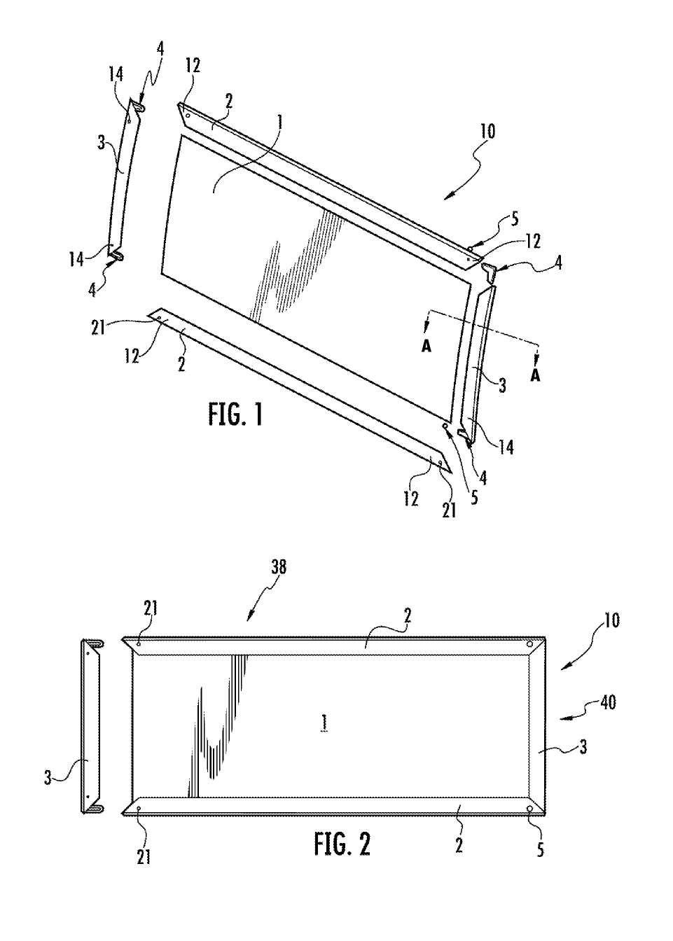

Referring to FIGS. 1 and 2, a frame assembly 10 in accordance with the present disclosure is illustrated. The frame assembly 10 forms a messaging tool for a vehicle, building, or other object having a flat or curved surface onto which the frame assembly 10 can be applied for the purpose of displaying a panel 1. The panel 1 can be any suitable material that is desired to be displayed including signage, advertising, artwork, or the like. The frame assembly 10 allows such a panel 1 to be easily removed and replaced. In this manner, one can change a display panel 1 with great ease. The frame assembly 10 is also designed so as to be virtually impervious to normal weather, wind, vibration, and temperature fluctuations.

Turning again to FIGS. 1 and 2, the frame assembly 10 includes frame members 2, 3. Horizontal frame members 2, 2 are separated from one another by vertical frame members 3, 3. Each horizontal frame member 2 includes two edges 12 on either side of its length that are joined to the respective two edges 14 of each vertical frame member (also located on either side of its length) at a 90 degree angle to form a rectangle. The frame members are joined together at each edge with connector element 4. Although a rectangular shaped frame assembly is illustrated, the frame members can be joined together to form a frame assembly having any suitable shape and/or size. For instance, two or more frame members can be used to form a circular shaped frame assembly. Similarly, an irregularly shaped frame assembly is also contemplated by the present disclosure.

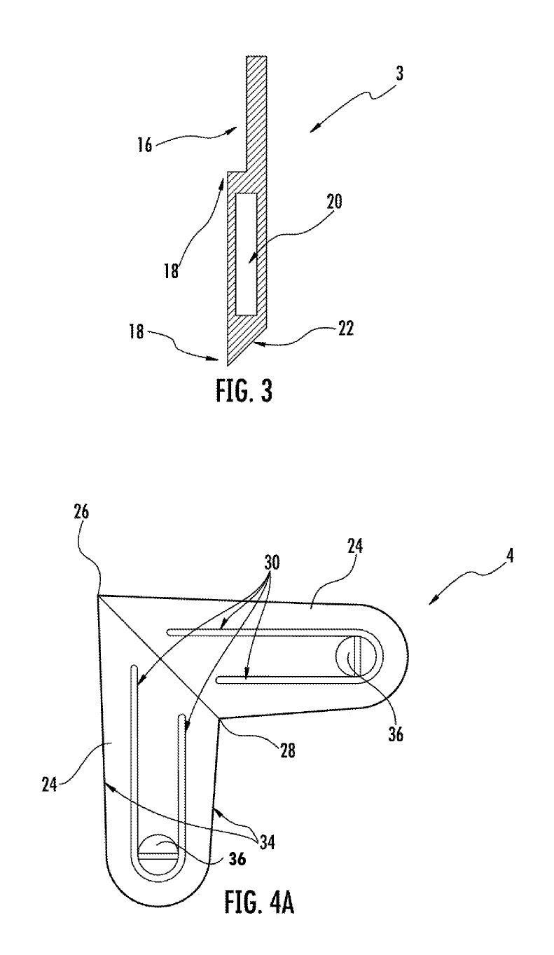

Referring to FIG. 3, a cross sectional view of the frame member 3 in FIG. 1 taken along line A-A is illustrated. Frame members can be fabricated or extruded of lightweight material (aluminum, plastic, or the like) to form the illustrated profile. Although a vertical frame member is illustrated, a similar configuration can be present for any other frame member, such as a horizontal frame member, in accordance with the present disclosure. The frame member defines a panel retainer flange 16 that extends from frame member to hold panel 1 in place when frame member is joined to other frame members to form a frame assembly. Panel retainer flange 16 is suitable for holding the panel in place against or adjacent to the object to which frame assembly is installed. Panel retainer flange 16 can be of any suitable length so as to prevent panel from unintentionally exiting frame assembly. Similarly, panel retainer flange 16 can be of any suitable thickness which provides adequate support for panel. FIG. 8 illustrates flange 16 as well as panel retaining seat 46 which can assist in limiting movement of panel 1.

Frame member also includes a generally flat surface 18 which can be utilized to affix frame member to a vehicle, building, or other surface as further described herein. However, it should be understood that other surface shapes such as angled, curved, or the like for frame member 18 are also contemplated depending upon the desired location of installation. Any suitable method of affixing frame members to a surface can be utilized. For instance, a double sided, non-permanent/removable adhesive can be applied to provide a fastening method to the object to which frame assembly is installed.

Frame member defines an opening 20 for corner connector 4. For example, in certain embodiments of the present disclosure, opening 20 is a cavity that extends along the entire length of frame member. In other embodiments, opening 20 can be located at the edges of frame member. As illustrated in FIG. 1, frame member defines two openings 20 Opening 20 is of suitable size to accommodate one leg of a corner connector with enough clearance to facilitate easy installation, yet tight enough to prevent excessive play and wear. Each frame member further defines another opening 21 for another portion of connector 4, as will be described in more detail herein. Again, as illustrated in FIG. 1, each frame member defines two second openings 21.

Frame member 20 can also define a beveled edge 22 to blend the frame member into the object to which it is attached, thereby eliminating the sharp edge that would be exposed when the frame assembly 10 is installed. Beveled edge 22 can have any suitable angle of incline depending on the overall size of the frame assembly as well as the surface upon which the same is installed.

The rear side of frame member 2 is illustrated in FIG. 8. As shown, a water drainage 42 slot to allow rain, melted ice, snow, or the like to evacuate the space between the panel and the frame member (in the illustrations, vertical frame members do not have this feature although it could be added if desired). Each frame member is caused to have unique geometry on each end to accommodate the corner connectors and provide them with a pathway for alignment. Frame member includes a clearance groove 44 to allow the corner connector to expand as it is forced toward the connector hole mentioned above (as will be described in more detail below). Similarly, a 45 degree mitered cut can provide the edges 12 matching corners of the frame assembly and allow access to the channels that receive the corner connectors. The sharp end of each frame member is provided with a radius to eliminate the sharp corner generated by the miter.

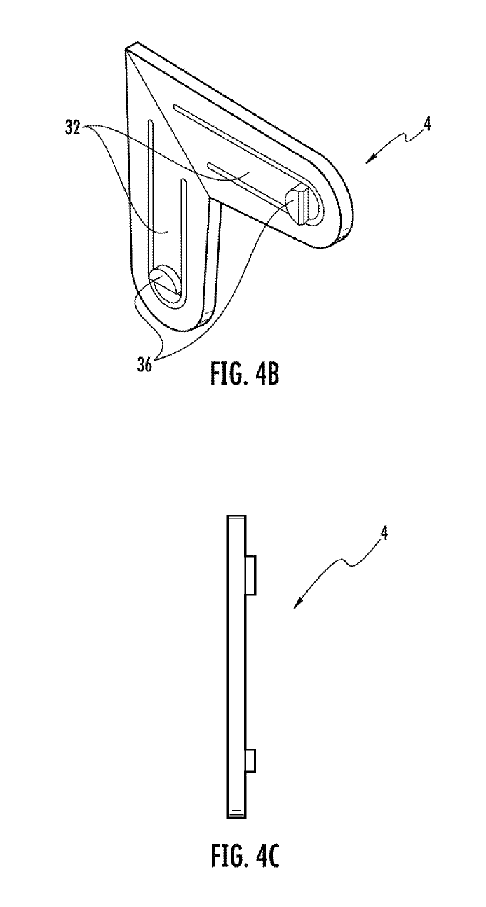

Referring to FIGS. 4A-4C, an exemplary embodiment of a corner connector 4 in accordance with the present disclosure is illustrated. It should be appreciated, however, that a corner connector having any suitable shape and/or size can be utilized in accordance with the present disclosure. Corner connectors utilized in connection with a frame assembly can be identical and are machined or molded of a suitable material to provide flexibility, toughness, and resistance to weather, vibration, wind, and temperature fluctuations (FIG. 1 utilizes four identical corner connectors). For instance, corner connector 4 can be injection molded polycarbonate, chosen for strength, toughness, and flexibility. Corner connector 4 provides various features and benefits for the frame assembly 10.

Each corner connector 4 includes two symmetrical legs 24 formed, in certain embodiments, at an angle of 90 degrees to each other. On the longest part of each leg 24, a short, straight length is provided such that a 90 degree corner 26 is formed. This corner 26 serves to position the corner connector 4 with respect to the opening 20 in the frame member and provides alignment of the mitered corners when the frame members 2, 3 are in final contact with each other. From this straight length the leg 24 tapers down along edge 34 to provide clearance during installation. The opposite side of each leg tapers from a spot on the line of symmetry 28 between the two legs along edge 34 to again provide clearance during installation. Within each leg is positioned a slot 30 that creates a flexible finger 32 in the center of each leg. Positioned on the end of each flexible finger 32 is a half button feature 36 which protrudes above the surface of the connector and serves to lock each corner connector in place within the opening 20 of the frame member by clicking into place in a hole 21 in the frame member which is located and sized specifically to accommodate the half button 36.

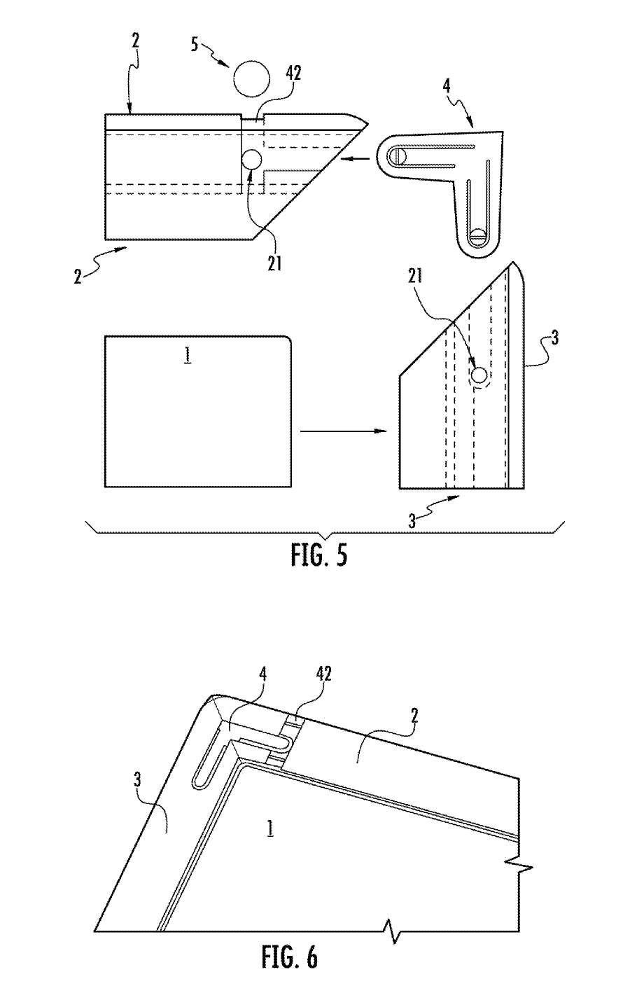

The thickness of the corner connector allows it to fit loosely in the opening 20 of the frame member. But the extra thickness of the half button 36 would prevent the connector 4 from sliding into the opening 20 except for the flexibility of the finger 32 and the open geometry of the frame member (as illustrated in FIGS. 5 and 6) that allow the finger to bend to accommodate the half button until it finds and clicks into the clearance hole 21 provided for it in each frame member and connects the frame members 2, 3. Clearance groove 44 (shown in FIG. 8) can assist in permitting movement of finger 32.

Because of the width of this groove 44, the finger 32 is allowed to bend into the groove while the rest of the leg 24 is retained in the walls of the opening 20. This allows the finger to find the hole while maintaining alignment of the frame members until the half button clicks into place. Note that the depth of the corner connector hole 21 will in certain circumstances be cut completely thru the part to allow the half button to be pushed and released when necessary to remove the panel and counter bored to a depth that will allow the half button to engage itself in the hole without creating an opening on the opposite side.

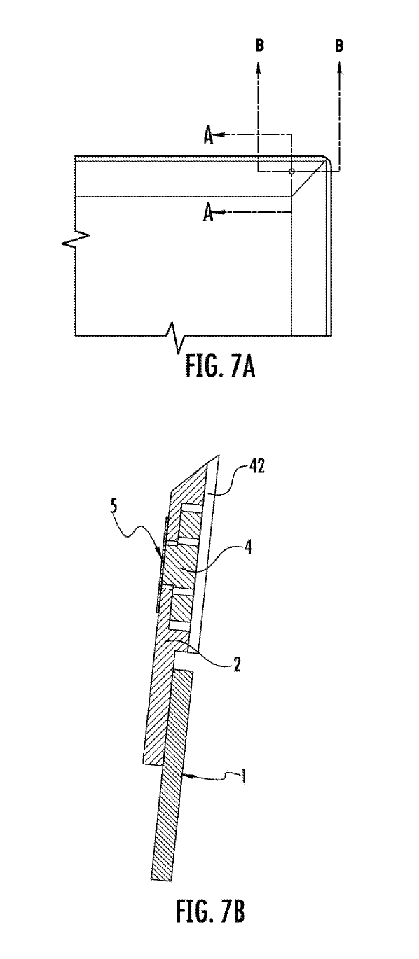

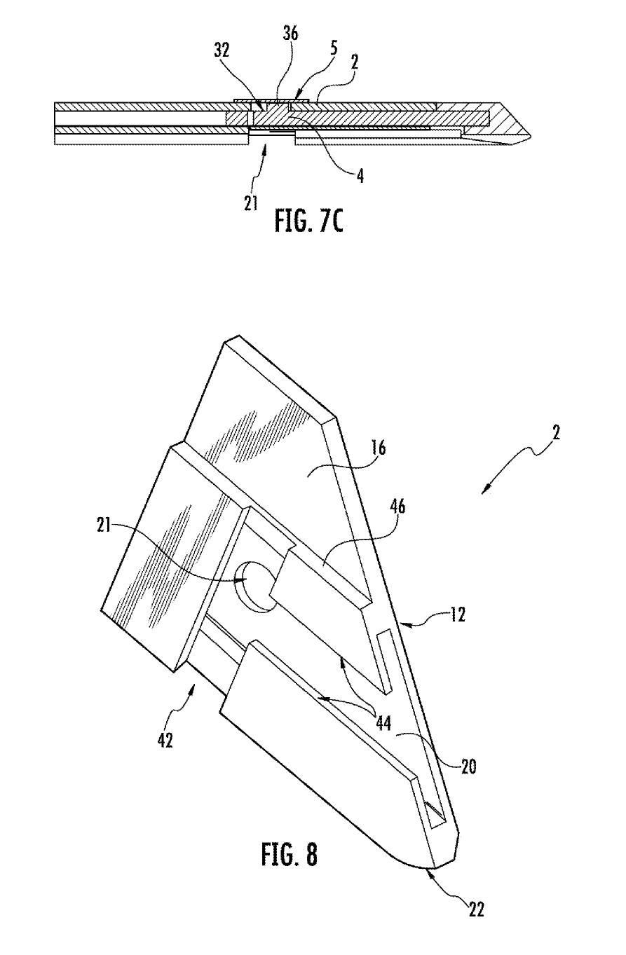

As illustrated in FIGS. 1, and 7A-7C, once the half buttons 36 have found and clicked into the clearance holes 21, the two frame members 2, 3 are aligned and locked in place until one of the half buttons 36 is depressed enough to allow the connector 4 to slide back out of the opening 20. The half buttons 36 are specifically designed to allow the use of any small pointed device (flat blade screw driver, ball point pen, etc) to simultaneously push the finger 32 inward and force it away from the hole 21. Once this is done for the two holes 21 that retain the frame member 2 which is connected to frame elements 2, 3, the frame member 2 and its two connectors 4 can be slid in a parallel direction to remove them from the assembly.

The frame members are removable (as illustrated in FIG. 2), to allow for the reversal or replacement of the panel 1. Again, it is contemplated that the frame members can be of any shape, length, or size to accommodate a variety of different applications. It should be evident that configurations other than the illustrated embodiments may require scaling of different components to address the application and strength requirements without representing a departure from the spirit of the present disclosure.

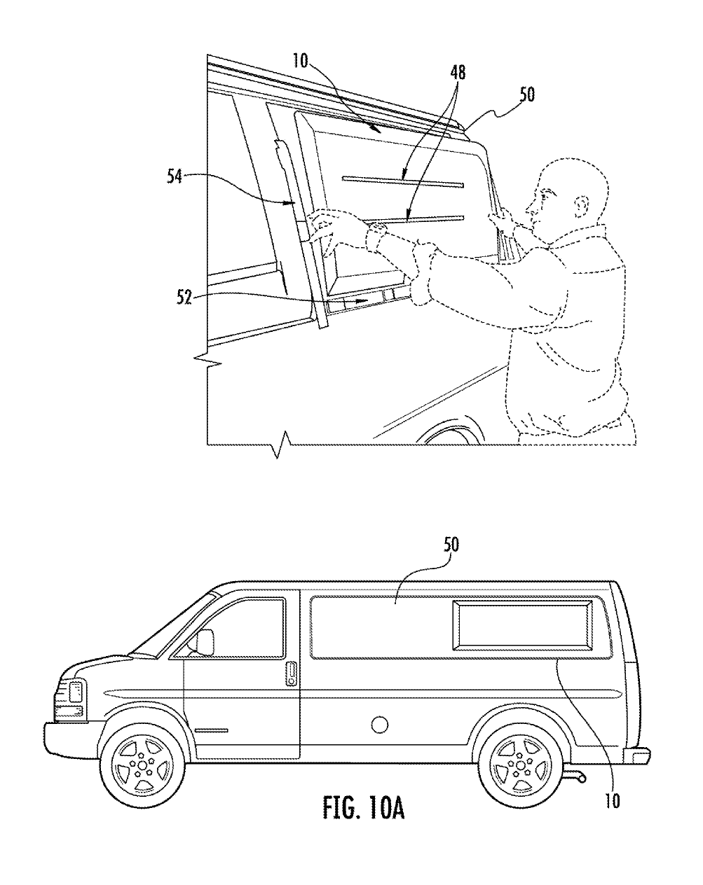

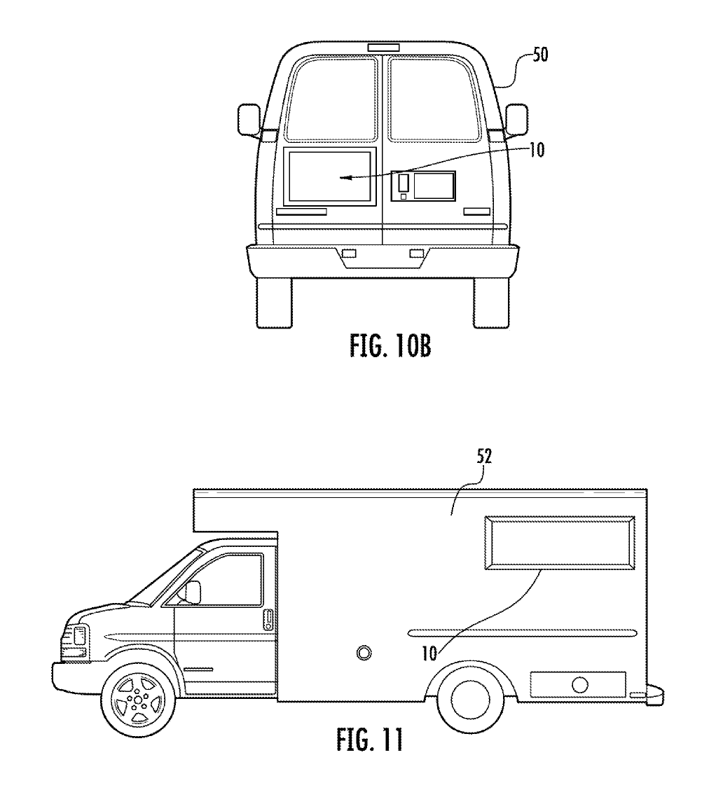

The removable panel 1 can be removed from the top 38 or side 40 (as shown in FIG. 2) of frame assembly, depending on the application. FIGS. 9 and 10A-10B illustrate the installation of a rectangular frame on the side and back of a utility van 50. However, any suitable vehicle can be utilized in connection with frame assembly. FIG. 11 illustrates the installation on the side of a box van 52. In both of the side installations, the left vertical frame member is removable. In the back installation, the top horizontal member is removable.

The removable frame member is held in place only by the action of the corner connectors as described further herein. A single sided adhesive tape can be applied at the interface between the vehicle and the frame member as a spacer (not shown). However, any suitable spacer mechanism as would be known in the art can be utilized. The adhesive tape is attached to the frame member, not the vehicle, allowing this removable frame member to slide as necessary during removal for replacement or reversal of the panel.

The fixed frame members can be attached to the vehicle with a double sided non-permanent and removable adhesive (not shown) that strongly adheres the frame members to the vehicle body. They can be removed and replaced if necessary without damaging the surface finish of the vehicle. There are no holes, hardware, or other devices to damage the vehicle or other surface to which it is applied. Removal is done mechanically by running a thin wire between the frame and the vehicle and then removing the tape residue with normal solvents such as lacquer thinner. Again, however, the present disclosure is not limited to vehicle installations and the frame assemblies described herein can also be utilized in connection with other surfaces, such as buildings.

Stringent cleaning techniques can be adopted for the mounting surfaces (both the surface and the frame member) to remove any contaminants that would reduce the adhesion of the tape. Removal of wax, dirt, and grease residue using a solvent such as alcohol is normally sufficient.

Maximum adhesion of the tape is found to be dependent upon the application temperature. Care should be taken to install the tape and frame when the ambient temperature is between 50-80° F. As shown in FIG. 9, attached to the surface behind the message panel are two or more magnetic or otherwise adhesively attached spacer strips 48. These strips serve the purpose of breaking the surface tension between the panel and the surface when it rains or the panel and/or surface otherwise becomes wet. Without these strips 48, the panel can be bonded to the surface by the surface tension of the water, and can be difficult to remove.

Any holes that are not used for future removal of a frame member can be covered with an adhesive backed hole cover 5 (illustrated in FIGS. 1, 2, 5, 7B and 7C) formed from plastic or the like to prevent the removal of the wrong connector when changing the panel. When the removable frame member is vertical, the hole covers are placed over the holes in the opposite ends of the horizontal members. When the removable member is horizontal, the hole covers are placed over the holes in the opposite ends of the vertical members. This variation is necessary to prevent the operator from attempting to remove one of the permanently fixed frame members rather than the appropriate removable frame member.

Initial installation of the frame system is achieved by removing the frame and components from the shipping container. Frame members can be provided already fitted with the appropriate adhesive tape and corner connectors. The frame and corner connectors can be assembled without the panel and without removing the cover on the exposed side of the double sided adhesive tape (the other side being joined to the frame member).

For instance, installation can be aided using special magnetic alignment tools as shown in FIG. 9. Once the position of the frame assembly has been determined and marked on the surface, a horizontal magnetic alignment tool 52 is affixed to the vehicle in a place to provide a locating position for the lower horizontal edge of the frame assembly. A vertical magnetic alignment tool 54 is affixed to the vehicle in a position perpendicular to and butted up against the horizontal magnetic alignment tool to provide the necessary corner relationship for the frame.

The cover is removed from the adhesive tape on the frame members that are to be affixed (as mentioned before, the removable frame member(s) are not affixed to the surface). The frame is positioned carefully in place using the alignment tools and then pressure is applied to cause the three fixed members to adhere to the surface. The removable frame member is removed from the assembly, leaving only the three fixed frame members in place. The panel is slid into place between the frame and the vehicle surface. The removable frame member is reinstalled, assuring that the half buttons click firmly into the corner connector holes. The magnetic alignment tools are removed.

After initial installation of the frame system, replacement or reversal of the panel is achieved by executing the steps above to remove and replace only the removable frame member.

These and other modifications and variations to the present disclosure can be practiced by those of ordinary skill in the art, without departing from the spirit and scope of the present disclosure. In addition, it should be understood that aspects of the various embodiments can be interchanged both in whole or in part. Furthermore, those of ordinary skill in the art will appreciate that the foregoing description is by way of example only, and is not intended to limit the disclosure.

What is claimed:

1. A frame assembly comprising:
at least two connector elements, each connector element comprising two legs, each leg comprising a tab;
at least two frame elements, each frame element defining a pair of first openings, each first opening being adapted for receiving a connector element leg, each frame element further comprising a pair of second openings, each second opening being adjacent to a first opening and being adapted for receiving a tab; and
a panel, wherein each frame element has a two different connector element legs joined thereto at each respective first opening and two different connector element tabs at each respective second opening such that the at least two frame elements are joined together to form a frame, with the panel being enclosed therein.

2. A frame assembly as in claim 1, having four connector elements and four frame elements.

3. A frame assembly as in claim 1, wherein the frame elements form a frame having a generally rectangular shape.

4. A frame assembly as in claim 1, wherein the frame elements form a frame having a generally circular shape.

5. A frame assembly as in claim 1, wherein each connector defines a surface and the tabs of each connector element are configured to extend above the plane defined by the surface in a first position and are configured to be generally planar with or below the surface in a second position.

6. A frame assembly as in claim 1, wherein the legs of each connector come together at generally a 90 degree angle.

7. A frame assembly as in claim 1, wherein the legs of each connector have generally tapered side edges.

8. A frame assembly as in claim 1, wherein the panel includes a first exterior layer and a second interior layer.

9. A frame assembly as in claim 1, wherein one or more frame elements comprise double sided adhesive tape.

10. A frame assembly as in claim 1, wherein one or more frame elements define a drain channel that extends through the frame element.

11. A frame assembly as in claim 1, wherein the one or more frame elements further comprise a flange, the flange extending from the frame element and being configured to cover a portion of the panel.

12. A method of installing a frame assembly comprising:
affixing at least one frame element to a surface, the frame element being joined to at least one other non-surface affixed frame element by at least two connector elements, each connector element comprising two legs, each leg comprising a tab, wherein each frame element defines a pair of first openings, each first opening being adapted for receiving a connector element leg, each frame element further comprising a pair of second openings, each second opening being adjacent to a first opening and being adapted for receiving a tab, wherein each frame element has a two different connector element legs joined thereto at each respective first opening and two different connector element tabs at each respective second opening such that the at least two frame elements are joined together to form a frame.

13. A method of installing a frame assembly as in claim 1, further comprising:
removing the non-surface affixed frame element;
sliding a panel having a first side and a second side into the remainder of the frame such that the first side is visible and the second side is adjacent to the surface; and
replacing the non-surface affixed frame element.

14. A method of installing a frame assembly as in claim 13, further comprising:
removing the non-surface affixed frame element;
sliding the panel out of the remainder of the frame;
sliding the panel back into the remainder of the frame such that the second side of the panel is visible and the first side is adjacent to the surface; and
replacing the non-surface affixed frame element.

15. A method of installing a frame assembly as in claim 13, wherein each connector defines a surface and the tabs of each connector element are configured to extend above the plane defined by the surface in a first position and are configured to be generally planar with or below the surface in a second position, the step of removing the non-surfaced affixed frame element requiring that a tab of at least one connector element be moved from the first position to the second position.

16. A method of installing a frame assembly as in claim 12, further comprising placing a cover over at least one second opening.

17. A method of installing a frame assembly as in claim 12, further comprising installing at least one spacer strip on the surface.

18. A method of installing a frame assembly as in claim 12, wherein the surface comprises a vehicle.

19. A method of installing a frame assembly as in claim 12, wherein the surface comprises a building.

20. A method of installing a frame assembly as in claim 12, wherein the frame elements form a frame having a generally rectangular shape.
